(19) United States
(12) Patent Application Publication
(10) Pub. No.: US 2012/0099319 A1
(43) Pub. Date: Apr. 26, 2012

(54) LIGHT EMITTING DIODE LAMP

(75) Inventor: TAY-JIAN LIU, Tu-Cheng (TW)

(73) Assignee: FOXCONN TECHNOLOGY CO., LTD., Tu-Cheng (TW)

(21) Appl. No.: 13/116,023

(22) Filed: May 26, 2011

(30) Foreign Application Priority Data
Oct. 20, 2010 (CN) 201010512884.0

(51) Int. Cl. F21S 4/00; F21V 29/00

(52) U.S. Cl. 362/249.02

(57) ABSTRACT

A light emitting diode lamp includes a lamp base, a lamp cover, and a number of illumination modules. Each illumination module includes a number of illumination units. Two opposite terminals of each illumination unit are secured to the lamp base near an edge of a corresponding opening. The illumination units are in the openings and apart from each other. Each illumination unit includes a hollow heat dissipating assembly, a lighting assembly, a printed circuit board, and two connection units connected to two opposite terminals of the hollow heat dissipating assembly. The printed circuit board controls a power supply through at least one of the connection units to the lighting assembly. The lamp cover has an inner wall surrounding the illumination modules. The inner wall defines a plurality of openings for receiving the terminals of the illumination units therein.

### BACKGROUND

1. Technical Field

The present disclosure relates to a light emitting diode (LED) lamp, and particularly, to an illumination module of an LED lamp.

2. Description of Related Art

LEDs have many advantages, such as high luminosity, low operational voltage, low power consumption, easy driving, long-term reliability, environmental friendliness for not having to use mercury (Hg), and high impact resistance, which have led to LEDs being widely used as light sources.

Radiant efficiency and lifespan of the LEDs may be distinctly reduced by high working temperatures if an LED illumination device does not include a highly efficient heat dissipating assembly.

Large LED illumination devices, such as streetlights, spotlights, and searchlights, include a base, a heat dissipating assembly defining a number of fins on one side of the base, an LED light source mounted on the base opposite to the heat dissipating assembly, a housing enclosing the LED light source, and a driving power source to drive the LED light source. However, the heavy weight and huge volume of the heat dissipating assembly cause a lot of work and cost for configuration, disassembly, and repair, especially for hanging illumination devices, such as streetlights.

In addition, because of various illumination applications and customer needs, different kinds of illumination devices are designed having quite different structures, since one illumination device usually cannot be adopted to different illumination applications. As such, design, development, and manufacture of the LED illumination devices are costly.

Accordingly, it is desirable to provide an LED lamp which can overcome the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a perspective view of a part of an LED lamp according to a first embodiment of the present disclosure, in which a portion of a lamp cover is not shown.

FIG. 2 is an unassembled view of the LED lamp of FIG. 1, but viewed from the back side.

FIG. 3 shows a partially exploded view of an illumination unit of FIG. 1.

FIG. 4 is an enlarged exploded view of one connection unit of FIG. 3, viewed from an opposite side.

FIG. 5 is an assembled, isometric view of an illumination unit according to a second embodiment of the present disclosure.

FIG. 6 is similar to FIG. 5, but the seal ring is draw out from the wire hole.

### DETAILED DESCRIPTION

Embodiments of the disclosure are now described in detail with reference to the accompanying drawings.

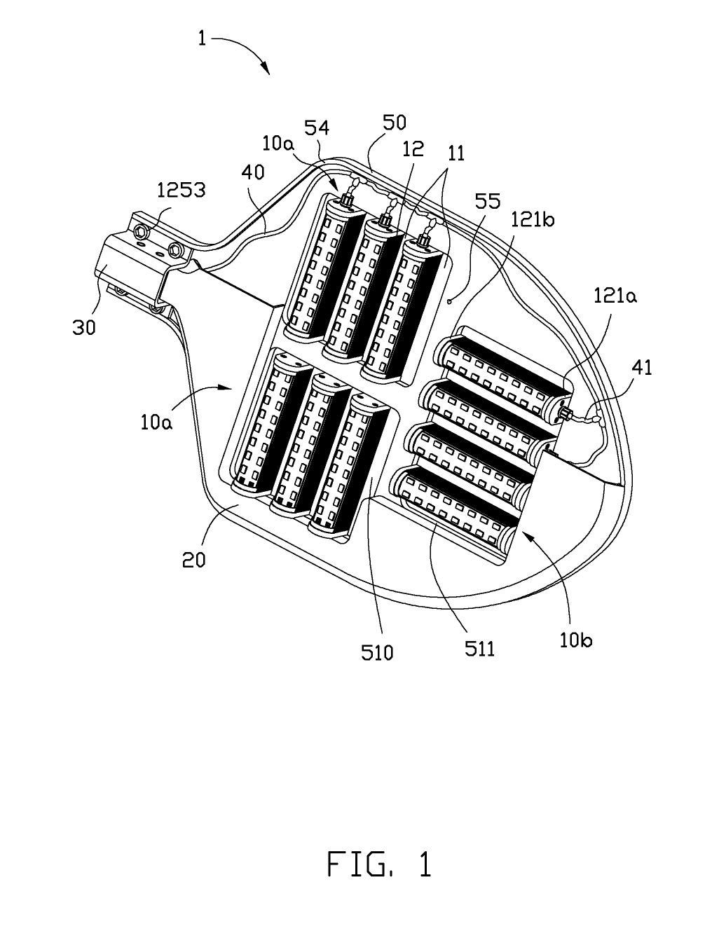

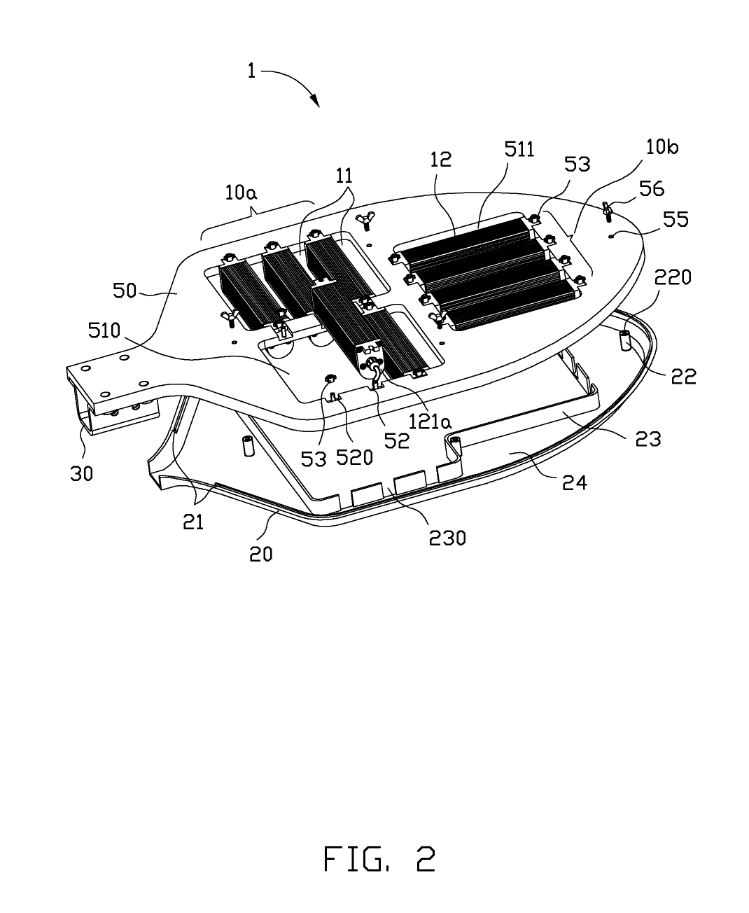

Referring to both FIG. 1 and FIG. 2, the LED lamp 1 includes two illumination modules 10a, one illumination module 10b, a lamp cover 20, a lamp base 50, a pole connection unit 30, two trunk power cords 40, ten branch power cords 41, four screws 1253, and four wing screws 56. The LED lamp 1 is, for example, a streetlight. In this embodiment, the LED lamp 1 is substantially symmetrical to a central line thereof. The pole connection unit 30 is fixed to the lamp base 50 by the four screws 1253, and can be connected to a pole or other support (not shown).

The lamp base 50 includes a sidewall 54 on the front side along the edge thereof, and defines two openings 510 corresponding to the two illumination modules 10a, one opening 511 corresponding to the illumination module 10b, and four holes 55 penetrating the lamp base 50. Each of the openings 510, 511 is substantially a rectangular opening. The lamp base 50 defines recesses 52 neighboring the openings 510, 511, and has threaded bolts 520 in the recesses 52 to hold the corresponding illumination module 10a or 10b in the openings 510, 511. Both the recesses 52 and the threaded bolts 520 are located at the back side of the LED lamp 1, opposite to the lamp cover 20.

Differences between the openings 510 and the opening 511 lie in positions, sizes, numbers, and locations of the recesses 52 and threaded bolts 520. The opening 511 is located far from the pole connected unit 30, and is parallel to the central line. There are eight recesses 52 and eight threaded bolts 520 adjacent to the opening 511. Four of the recesses 52 are located near an edge of the opening 511 far from the pole connected unit 30, and the other four recesses 52 are located near an edge of the opening 511 opposite thereto. The two openings 510 are located between the above-mentioned opening 511 and the pole connected unit 30, and are perpendicular to the central line. The two openings 510 are identical to each other, and symmetrical to the central line. There are six recesses 52 and six threaded bolts 520 adjacent to each opening 510. Three of the recesses 52 are located near an edge of the opening 510 adjacent to the central line, and the other three recesses 52 are located near an edge of the opening 510 opposite thereto.

Differences between the illumination modules 10a and the illumination module 10b lie in positions, sizes, numbers, and directions of illumination units 12. Each illumination module 10a includes three illumination units 12 located in one of the openings 510, and six T-nuts 53 located at two opposite ends of the three illumination units 12. Each illumination unit 12 of the illumination modules 10a is arranged perpendicular to the central line of the LED lamp 1. The illumination module 10b includes four illumination units 12 located in the opening 511, and eight T-nuts 53 located at two opposite ends of the four illumination units 12. Each illumination unit 12 of the illumination module 10b is arranged parallel to the central line of the LED lamp 1.

The trunk power cords 40 enter the LED lamp 1 from the space defined between the pole connection unit 30 and the lamp base 50, and are located between the lamp cover 20 and the lamp base 50. The two trunk power cords 40 are arranged along the edges of the lamp base 50, and are opposite to each other. Each trunk power cord 40 is electrically connected to five illumination units 12, including three illumination units 12 of one illumination module 10a and two illumination units 12 of the illumination module 10b, through five branch power cords 41. For each illumination unit 12, current is supplied thereto through one branch power cord 41.

The shape of the lamp cover 20 substantially corresponds to the lamp base 50. The lamp cover 20 has a stepped sidewall 21 corresponding to the sidewall 54 of the lamp base 50 for fitting engaging therewith, and an inner wall 23 for surrounding the illumination modules 10a, and 10b. In assembly, the sidewall 54 fittingly engages with the stepped sidewall 21. The lamp cover 20 defines four protrusion cylinders 22 corresponding to the holes 55 of the lamp base 50, and a receiving space 24 enclosed by the lamp cover 20 and the lamp base 50 and located between the stepped sidewall 21 and the inner wall 23 to receive the trunk power cords 40 and the branch power cords 41. Each protrusion cylinder 22 defines a threaded hole 220 therein. There inner wall 23 defines ten openings 230 therethrough for extension of ten terminals (not labeled) of the illumination units 12 therein.

The illumination units 12 are assembled to the lamp base 50 from the back side. Two opposite ends of each illumination unit 12 are respectively positioned in two opposite recesses 52, and are penetrated by two threaded bolts 520. The T-nuts 53 are respectively screwed to the threaded bolts 520 to fix the illumination units 12. The illumination units 12 are apart from each other, and define gaps 11 therebetween to enhance natural convection, and to reduce weight of the LED lamp 1. The gaps 11 allow wind, snow, rainwater and dust to pass through, so as to prevent possible load caused by these foreign matter on the LED lamp 1.

Assembly of the lamp cover 20 includes positioning the lamp cover 20 on a predetermined position of the lamp base 50, on which the outer surface of the stepped sidewall 21 hermetically engages with the inner surface of the sidewall 54, and next screwing the four wing screws 56 respectively through the four holes 55 into the four threaded holes 220 of the protrusion cylinders 22.

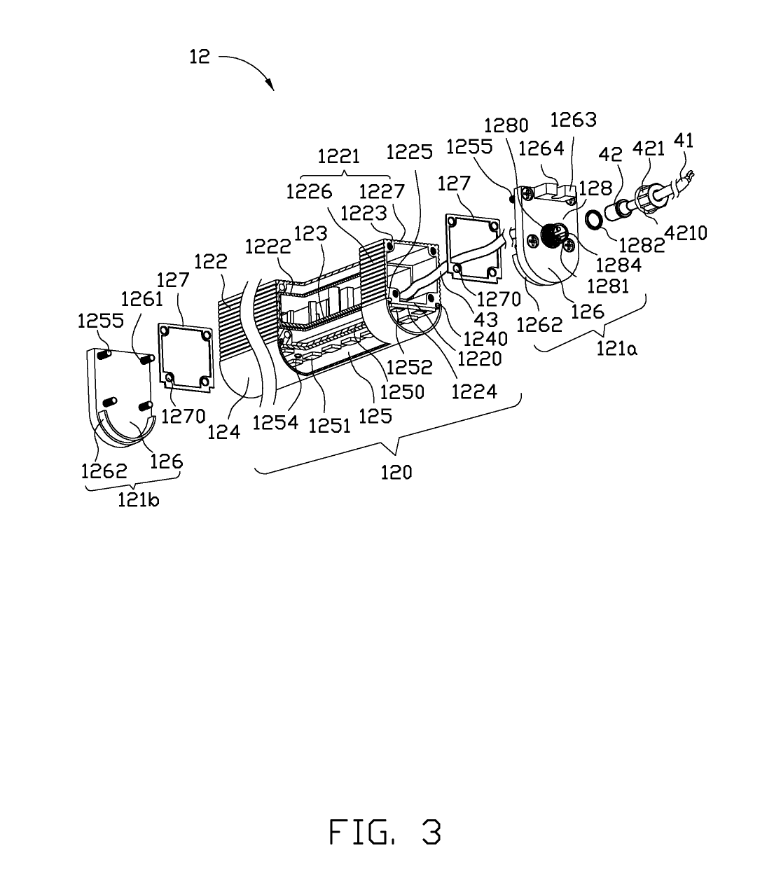

As shown in FIG. 3, each illumination unit 12 is relatively long and narrow. Each illumination unit 12 includes a long lamp module 120, and two connection units 121a and 121b connected to two opposite terminals of the lamp module 120. Each lamp module 120 includes a long, hollow, heat dissipating assembly 122, at least one lighting assembly 125, a printed circuit board 123, and a long light guide housing 124.

The heat dissipating assembly 122 is made of thermally conductive material, such as metal. The heat dissipating assembly 122 includes a heat dissipating base 1220 and a heat dissipating case 1221, which together define a hollow rectangular space therein. Located corresponding to each of the opposite terminals of the lamp module 120, the heat dissipating case 1221 further defines four screw holes 1223 at four corners thereof. The heat dissipating assembly 122 provides protection to ensure the reliability of the illumination units 12. The metal wall of the heat dissipating assembly 122 provides electromagnetic shielding to protect the circuits and elements therein.

The heat dissipating base 1220 is substantially a plate. The outer surface of the heat dissipating base 1220 is an endothermic surface 1224 contacting the lighting assembly 125. The heat dissipating base 1220 defines two grooves 1225 respectively located on two opposite side surfaces thereof. Two terminal edges of the light guide housing 124 are received in the two grooves 1225. As such, the heat dissipating base 1220 can seal a top opening of the light guide housing 124.

The heat dissipating case 1221 includes two sidewalls 1226 and a top plate 1227. The top plate 1227 is parallel to the heat dissipating base 1220, and is apart from the heat dissipating base 1220. The two sidewalls 1226 are located on two opposite edges of the top plate 1227, and extend from the top plate 1227 down to the heat dissipating base 1220. The sidewalls 1226 and the top plate 1227 include heat-dissipating structures on the outer surfaces thereof, such as narrow fins shown in FIG. 3, to improve heat dissipation. It is noted that the heat-dissipating structures are not limited to the shown embodiment, and may include any appropriate shapes, such as columns or wide fins.

The lighting assembly 125 is located under the hollow heat dissipating assembly 122. The lighting assembly 125 includes a rectangular light source base 1250, a number of LED elements 1251 located on the light source base 1250, and a number of electrodes 1252. The electrodes 1252 are formed on a lower surface of the light source base 1250, and are electrically connected to the LED elements 1251. Each LED element 1251 may include at least one LED chip sealed by a transparent material. The light source base 1250 of the lighting assembly 125 contacts the endothermic surface 1224 of the heat dissipating base 1220. The heat dissipating base 1220 may include a thermal interface material (TIM, not labeled) coated between the light source base 1250 and the endothermic surface 1224. The light source base 1250 may be tightly fixed to the heat dissipating base 1220 by screws 1254. The heat produced from the LED elements 1251 can be effectively transferred from the lighting assembly 125 to the nearby heat dissipating case 1221. The temperature difference between the illumination units 12 and the surroundings causes natural convection in the gaps 11, and the large outer surface of the heat dissipating assembly 122 and the gaps 11 make the natural convection more active. Thus, heat dissipation of the present disclosure is better than that of a traditional LED lamp.

The printed circuit board 123 is located in the hollow space defined by the heat dissipating assembly 122. The branch power cord 41 is electrically connected to the electrode (not shown) of the printed circuit board 123. The printed circuit board 123 transmits driving current to the lighting assembly 125, and controls the power supplied to the LED elements 1251. Since the hollow heat dissipating assembly 122 is made of metal in this embodiment, the lamp module 120 further includes an electrically insulating sleeve 1222 located in the hollow heat dissipating assembly 122 to surround the printed circuit board 123. The sleeve 1222 electrically insulates the printed circuit board 123 from the hollow heat dissipating assembly 122. The sleeve 1222 can be made of thermally conductive material to enhance heat dissipation.

The light guide housing 124 is a transparent arc shaped housing covering the lighting assembly 125. The light guide housing 124 includes two flanges 1240 respectively at two opposite edges corresponding to the two grooves 1225 of the heat dissipating base 1220. The two flanges 1240 are parallel to the extension direction of the lamp module 120. The two flanges 1240 extend inward and respectively insert into the two grooves 1225 of the heat dissipating base 1220. As such, the light guide housing 124 is fixed to the heat dissipating base 1220. The light guide housing 124 can adjust the illumination distribution of the LED lamp 1, and protects the lighting assembly 125. In other embodiments, each illumination unit 12 may further include lenses or reflective elements to enhance the optical performances of the LED elements 1251 of the LED lamp 1, for example, illumination distribution and brightness.

The two connection units 121a and 121b are located at two opposite terminals of the lamp module 120, and hermetically seal the lamp module 120. Each of the connection units 121a and 121b includes a cover 126, a seal piece 127 and four screws 1255.

Each cover 126 includes a location piece 1262 facing the lamp module 120 and a protrusion piece 1263 opposite to the lamp module 120, and defines four screw holes 1261. The location pieces 1262 are respectively inserted into two opposite terminals of the lamp module 120 and hermetically engage with the inner surface of the light guide housing 124. The four screw holes 1261 correspond to the four screw holes 1223. Each seal piece 127 is located between the corresponding cover 126 and the lamp module 120. Each seal piece 127 defines four screw holes 1270 corresponding to the four screw holes 1261 and the four screw holes 1223. For each of the connection units 121a and 121b, the four screws 1255 penetrate the four screw holes 1261, the four screw holes 1270 and the four screw holes 1223, so the covers 126 and the seal pieces 127 seal the heat dissipating case 1221, to make the illumination units 12 waterproof.

Each protrusion piece 1263 defines a hole 1264. Each illumination unit 12 is fixed to the lamp base 50 by two threaded bolts 520 shown in FIG. 2 penetrating the two holes 1264, and the two T-nuts 53 shown in FIG. 2 respectively screwed onto the two threaded bolts 520.

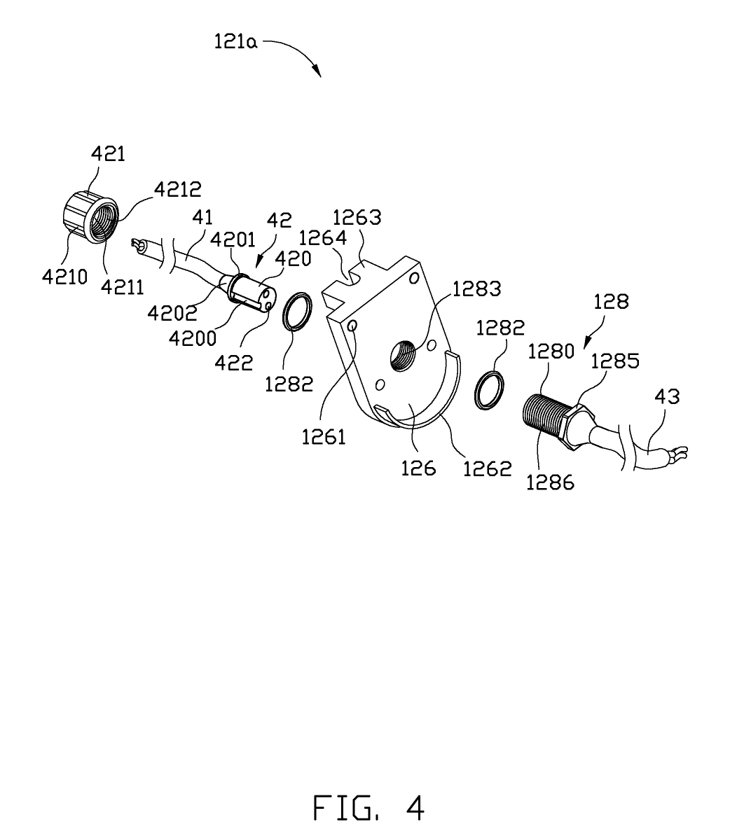

Referring to both FIG. 3 and FIG. 4, different from the connection unit 121b, the connection unit 121a shown in the right of FIG. 3 further includes a power cord 43, two seal rings 1282, and a cap 421, and the cover 126 of the connection unit 121a further defines a threaded hole 1283 to hold the power cord 43.

The power cord 43 includes a first terminal 128 to connect with the branch power cord 41, and the first terminal 128 is substantially a plug. The first terminal 128 includes a fixing portion 1280 and two contact pins 1281 located in the fixing portion 1280. The fixing portion 1280 is substantially a hollow bolt, including thread 1286 on the outer surface, a hexagonal head portion 1285, and a tenon bar 1284 on the inner surface.

The branch power cord 41 includes a second terminal 42 inserted into the fixing portion 1280, and the second terminal 42 is substantially a socket. The second terminal 42 includes an electrically insulating socket base 420, a protrusion portion 4201 and a cone portion 4202, wherein the protrusion portion 4201 is located between the socket base 420 and the cone portion 4202. The socket base 420 defines two socket holes 422 for engagingly receiving the contact pins 1281 and a locking groove 4200 for engagingly receiving the tenon bar 1284.

The cap 421 defines a hole 4211 at the center of the end to hold the branch power cord 41, threads 4211 on the inner surface to engage with the threads 1286 on the outer surface of the fixing portion 1280, a number of protrusion stripes 4210 on the outer surface. The protrusion stripes 4210 are arranged parallel to the axial direction of the cap 421 for the convenience of rotating the cap 421.

Connection of the connection unit 121a includes threading through one of the seal rings 1282 with the fixing portion 1280, and screwing the fixing portion 1280 into the threaded hole 1283. Accordingly, threads on the inner surface of the threaded hole 1283 threadedly engage with the threads 1286, and the seal ring 1282 is tightly sandwiched by the hexagon head portion 1285 and the cover 126. The seal ring 1282 seals the threaded hole 1283, and the fixing portion 1280 and the contact pins 1281 protrude from the cover 126. Next, the illumination units 12 are fixed to the lamp base 50. Thereafter, the cap 421 and another seal ring 1282 are threaded through by the branch power cord 41. Afterward, the second terminal 42 inserts into the fixing portion 1280. The tenon bar 1284 and the two contact pins 1281 are fittingly received into the locking groove 4200 and two socket holes 422. Accordingly, currents are supplied from the trunk power cord 40, the branch power cord 41, and the power cord 43 to the LED elements 1251. Next, the cap 421 is screwed onto the fixing portion 1280. The cap 421 pushes the second terminal 42 and the seal ring 1282, so the seal ring 1282 is tightly sandwiched by the protrusion portion 4201 and the fixing portion 1280. Connection between the first terminal 128 and the second terminal 42 is waterproof.

Both the branch power cord 41 and the power cord 43 include two wires therein to supply currents which flow from p-type material to n-type material in LEDs.

Accordingly, the LED lamp 1 can be easily assembled and disassembled without tools. The illumination modules 10a and 10b and the illumination units 12 of the present disclosure can be produced in batches, and numbers and arrangements of the illumination modules 10a and 10b and the illumination units 12 can be easily adjusted. Since the LED lamp 1 is formed by the modularized illumination modules 10a and 10b and illumination units 12, the LED lamp 1 can be easily modified for various applications. In addition, the connection units 121a and 121b enable easier manual repair of the suspended LED lamp. Repairmen can quickly replace the illuminating unit 12 without tools.

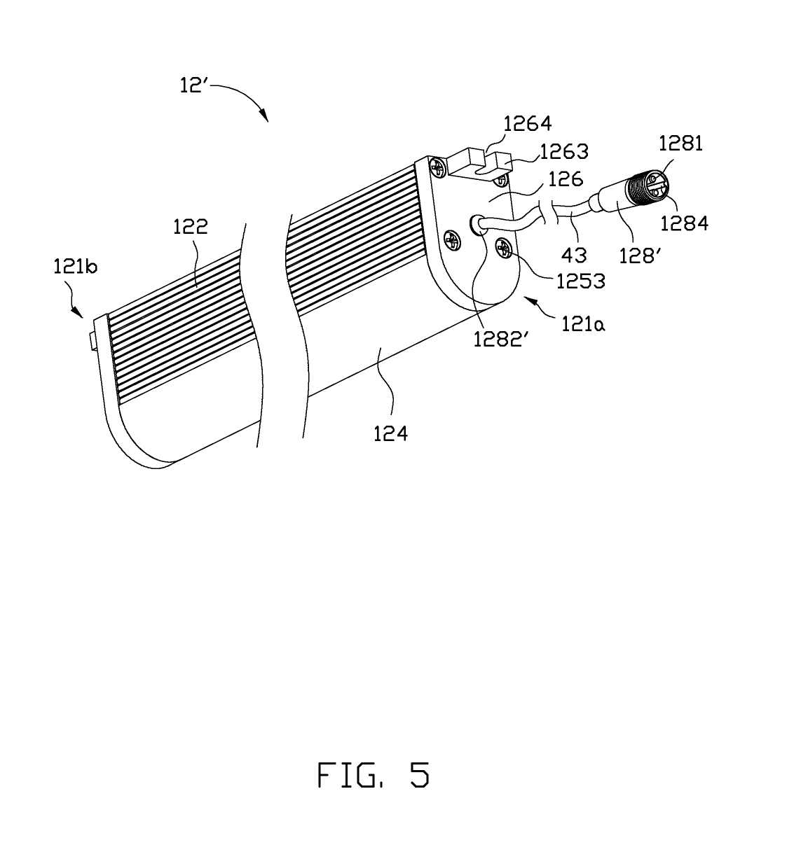

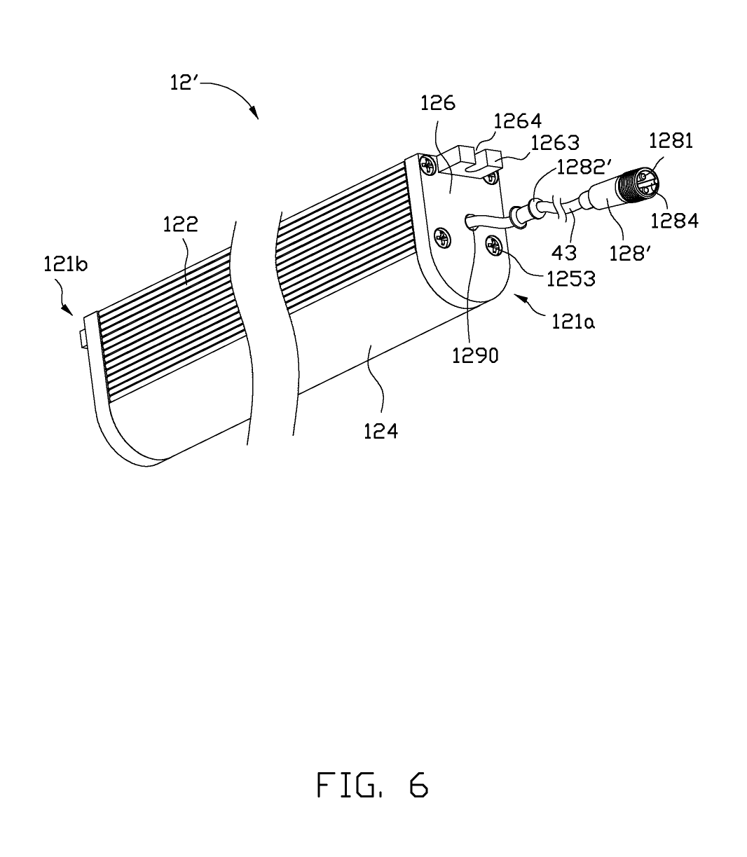

FIG. 5 and FIG. 6 illustrate an illumination unit 12′ according to a second embodiment of the present disclosure. As shown in FIG. 5 and FIG. 6, the main difference between the illumination unit 12 and the illumination unit 12′ is that the power cord 43 connecting to the printed circuit board (not shown) penetrates a wire hole 1290 of the cover 126, and then the first terminal 128′ connected to the second terminal of the branch power cord (not shown). The connection unit 121a includes a seal ring 1282′ set between the power cord 43 and the wire hole 1290 of the cover 126. The seal ring 1282′ is elastic, and tightly engages with both the power cord 43 and the wire hole 1290 to seal the illumination unit 12′. In addition, connection between the first terminal 128′ (plug) and the second terminal (socket) can also be waterproof. Thus, the positions of the first terminal 128′ and the second terminal do not have to be limited to be adjacent to the connection unit 121a, and the designs of the lamp cover and LED lamp can be more versatile.

Any of the above-mentioned electrical connections can be changed as required. For example, any of the first terminal and second terminal can be replaced by a socket, and any of the second terminal can be replaced by a plug. In another embodiment, one illumination unit 12 or 12′ may include both a plug and a socket located on two terminals thereof to connect to corresponding socket and plug of the branch power cord.

The illumination units 12 and 12′ integrate electrics, optics and heat dissipation, and can operate individually. The sizes, numbers, shapes and arrangements of the illumination modules 10 and 10′, the connection units 121a and 121b, the lamp cover 20, the lamp base 50, the illumination units 12 and 12′, and the openings 511, 510 are not limited by the above-mentioned embodiments, and can be adjusted as required for different applications. The components and arrangements in the two embodiments can be applied to each other as required.

Accordingly, the present disclosure includes the following advantages:

First, the LED lamp of the present disclosure can be easily modified because of the use of the modularized illumination units. The illumination units integrate electrics, optics and heat dissipation, and can operate individually. The different numbers, sizes, arrangements and shapes of the illumination modules, the connection units, the lamp base, the lamp cover, the illumination units and the openings can be easily modified and recombined. Thus, various applications and customer needs can be easily achieved. The manufacture of the LED lamps is simplified, and the cost can be effectively reduced.

Secondly, the LED lamp of the present disclosure provides great thermal efficiency. The hollow heat dissipating assembly has a large heat absorbing area and a large dissipating area, and the gaps between the illumination units enhance natural convection. As such, illuminating efficiency and light weight of the LED lamp are ensured, and lifetime of the LED lamp is increased.

Thirdly, the LED lamp of the present disclosure reduces the cost of disassembly and repair. The connection units enable easier manual repair of the suspended LED lamp. Repairmen can quickly replace the illuminating unit without tools. Accordingly, the LED lamp provides better maintenance quality, assembly convenience, and disassembly convenience.

Fourthly, the present disclosure provides an outdoor LED lamp with excellent weatherability. The LED lamp is protected from rain, humidity, dust, sunshine. The snow load, the drag coefficient, the amount of dust and sand deposition are reduced. Thus, safety and reliability are enhanced.

It is to be understood, however, that even though numerous characteristics and advantages of the present embodiments have been set fourth in the foregoing description, together with details of the structures and functions of the embodiments, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A light emitting diode (LED) lamp, comprising:
a lamp base, the lamp base defining a plurality of openings;
a plurality of illumination modules located on the lamp base and corresponding to the plurality of openings, each of the plurality of illumination modules comprising:
a plurality of illumination units apart from each other, each of the plurality of illumination units comprising:
a hollow heat dissipating assembly;
at least one lighting assembly contacting the hollow heat dissipating assembly whereby heat generated by the at least one lighting assembly is absorbed by the hollow heat dissipating assembly;
two connection units respectively sealing two opposite terminals of the hollow heat dissipating assembly; and
at least one printed circuit board electrically connected to the at least one lighting assembly, the at least one printed circuit board controlling a power supply through at least one of the two connection units to the at least one lighting assembly; and
a lamp cover located on the lamp base, wherein the lamp cover having an outer sidewall engaging with an outer sidewall of the lamp base and an inner wall surrounding the plurality of illumination modules.

2. The LED lamp of claim 1, wherein the outer sidewall of lamp base is located along an outer edge thereof and extends toward the lamp cover, and the outer sidewall of the lamp cover is a stepped sidewall engaging with the outer sidewall of the lamp base.

3. The LED lamp of claim 1, wherein a gap is defined between two neighboring ones of the plurality of illumination units for facilitating natural convection between the illumination units.

4. The LED lamp of claim 1, wherein the inner wall define a plurality of openings therein to hold terminals of the plurality of illumination units.

5. The LED lamp of claim 1, further comprising a plurality of trunk power cords, and a plurality of branch power cords electrically connecting the plurality of trunk power cords and the plurality of illumination units.

6. The LED lamp of claim 5, wherein the lamp base and the lamp cover defines a receiving space therebetween to receive the plurality of trunk power cords and the plurality of branch power cords.

7. The LED lamp of claim 1, wherein the lamp base defines a plurality of holes, and the lamp cover defines a plurality of protrusion cylinders corresponding to the holes.

8. The LED lamp of claim 7, further comprising a plurality of wing screws respectively screwed through the plurality of protrusion cylinders and the plurality of holes of the lamp base.

9. The LED lamp of claim 1, wherein the lamp base defines a plurality of recesses near at least one edge of each of the plurality of openings of the lamp base and located opposite to the lamp cover, and a plurality of threaded bolts in the recesses opposite to the lamp cover, the threaded bolts being provided for holding the plurality of illumination units in position.

10. The LED lamp of claim 1, wherein each of the plurality of illumination units further comprises a light guide housing.

11. The LED lamp of claim 10, wherein the hollow heat dissipating assembly comprises a heat dissipating base and a heat dissipating case, which together define a hollow space therein.

12. The LED lamp of claim 11, wherein the heat dissipating base defines two grooves respectively located on two opposite side surfaces thereof.

13. The LED lamp of claim 12, wherein two terminal edges of the light guide housing are received in the two grooves of the heat dissipating base.

14. The LED lamp of claim 13, wherein each of the two connection units comprises:
a cover;
a seal piece located between the cover and the hollow heat dissipating assembly; and
a plurality of screws for securing the cover and the seal piece to the hollow heat dissipating assembly.

15. The LED lamp of claim 14, wherein each of the covers comprises:
a location piece facing the at least one lighting assembly and contacting an inner surface of the light guide housing; and
a protrusion piece opposite to the at least one lighting assembly.

16. The LED lamp of claim 14, wherein at least one of the covers comprises:
a power cord connected to the at least one printed circuit board;
two seal rings located on two opposite sides of the cover; and
a cap holding a corresponding one of the branch power cords and fixed to the power cord.

17. The LED lamp of claim 16, wherein the power cord comprises a plug, and the corresponding one of the plurality of branch power cords comprises a socket to connect with the plug of the power cord.

18. The LED lamp of claim 16, wherein the at least one of the cover further defines a threaded hole to hold the power cord.

19. The LED lamp of claim 18, wherein the cap comprises threads on an inner surface thereof.

20. The LED lamp of claim 19, wherein the plug of the power cord comprises threads on an outer surface thereof to threadedly engage with both the threaded hole of the one of the covers and the threads of the cap.
